(19) United States
(12) Patent Application Publication
(10) Pub. No.: US 2025/0355444 A1
(43) Pub. Date: Nov. 20, 2025

(54) INFORMATION PROCESSING APPARATUS AND CONTROL METHOD THEREOF

(71) Applicant: CANON KABUSHIKI KAISHA, Tokyo (JP)

(72) Inventors: KEIICHI YAMAMOTO, Kanagawa (JP); MASAKAZU FUJIKI, Kanagawa (JP)

(21) Appl. No.: 19/197,067

(22) Filed: May 2, 2025

(30) Foreign Application Priority Data
May 17, 2024 (JP) 2024-081117

(51) Int. Cl. G05D 1/644; G05D 1/69; G05D 105/10

(52) U.S. Cl. CPC G05D 1/644; G05D 1/69; G05D 2105/10

(57) ABSTRACT

An information processing apparatus obtains information regarding a moving speed of each of a plurality of moving devices that will be performing work in a shared manner over an entire work area; obtains information on a work area assigned to each of the plurality of moving devices; and determines a work route of each of the plurality of moving devices based on a moving speed of each of the plurality of moving devices and a work area of each of the plurality of moving devices. The determination unit determines a work route of each of the plurality of moving devices based on a change in distance between the plurality of moving devices or a change in time required for movement between the plurality of moving devices after work of the plurality of moving devices is started.

### BACKGROUND OF THE INVENTION

### Field of the Invention

The present invention relates to a technique of determining a moving path of a moving device.

### Description of the Related Art

A plurality of cleaning robots, a plurality of infrastructure inspection robots, a plurality of serving and delivery robots, and the like have been increasingly work on work target areas in a shared manner. Japanese Patent Laid-Open No. 2015-147091 (Patent Document 1) discloses a technique of handing over work by allocating an area where work is not finished to another robot that has ended work.

However, in Patent Document 1, depending on a position relationship between a plurality of robots that perform work handover, handover cannot be performed efficiently, and it may take time to complete the entire work.

### SUMMARY OF THE INVENTION

According to one aspect of the present invention, an information processing apparatus comprises: a first obtaining unit that obtains information regarding a moving speed of each of a plurality of moving devices that will be performing work in a shared manner over an entire work area; a second obtaining unit that obtains information on a work area assigned to each of the plurality of moving devices; and a determination unit that determines a work route of each of the plurality of moving devices based on a moving speed of each of the plurality of moving devices and a work area of each of the plurality of moving devices, wherein the determination unit determines a work route of each of the plurality of moving devices based on a change in distance between the plurality of moving devices or a change in time required for movement between the plurality of moving devices after work of the plurality of moving devices is started.

The present invention efficiently performs work handover between a plurality of moving devices.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a view describing a usage scene of an information processing apparatus.

FIG. 2 is a view illustrating a functional configuration of the information processing apparatus.

FIG. 3 is a view illustrating a hardware configuration of the information processing apparatus.

FIG. 4 is a flowchart of processing executed by the information processing apparatus (first embodiment).

FIG. 5 is a detailed flowchart of route determination processing (first embodiment).

FIG. 6 is a view illustrating an example of route determination (first embodiment).

FIG. 7 is a detailed flowchart of route determination processing (second embodiment).

FIG. 8 is a view illustrating an example of route determination (second embodiment).

FIG. 9 is a view illustrating a functional configuration of the information processing apparatus (third embodiment).

FIG. 10 is a flowchart of processing executed by the information processing apparatus (third embodiment).

FIG. 11 is a view illustrating an example of route determination (third embodiment).

FIG. 12 is a view illustrating a functional configuration of the information processing apparatus (fourth embodiment).

FIG. 13 is a flowchart of processing executed by the information processing apparatus (fourth embodiment).

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

In the first embodiment, an information processing apparatus that determines moving paths (work routes) of a plurality of moving devices (work robots) in consideration of time required for movement between work end positions of the respective moving devices will be described.

### Usage Scene

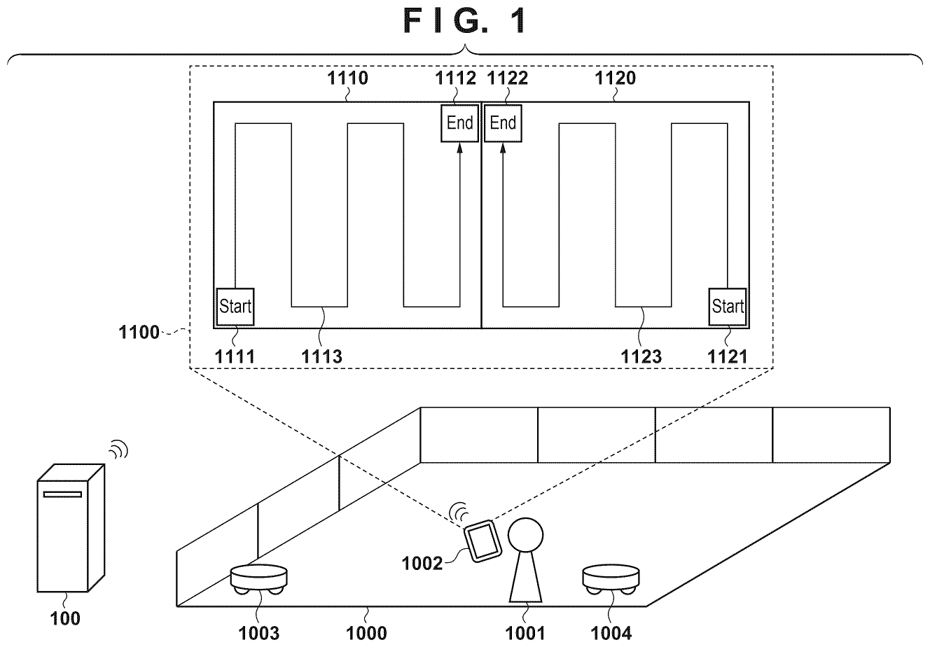

FIG. 1 is a view describing a usage scene of an information processing apparatus 100. The information processing apparatus 100 performs control such that work (e.g., cleaning) in an entire work area 1000 is performed in a shared manner by two moving devices (moving devices 1003 and 1004). The information processing apparatus 100 receives various instructions from a user 1001 via an operation of a terminal 1002 and provides various types of information to the user 1001.

The terminal 1002 is a smartphone, a tablet terminal, or a personal computer (PC). The information processing apparatus 100 is an instance on a server, a PC, or a cloud. The terminal 1002 communicates with the information processing apparatus 100 to display information transmitted from the information processing apparatus 100 and transmit content operated by the terminal 1002 to the information processing apparatus 100. Based on an instruction from the user by the terminal 1002, the information processing apparatus 100 causes the entire work area 1000 to be shared by the moving device 1003 and the moving device 1004 and determines work routes in respective assigned areas. For example, the user 1001 can confirm, via a screen 1100 displayed on a display screen of the terminal 1002, the content determined by the information processing apparatus 100. Note that here, each apparatus is assumed to perform wireless communication via a wireless local area network (LAN), but may perform other types of wireless communication or may perform wired communication partially.

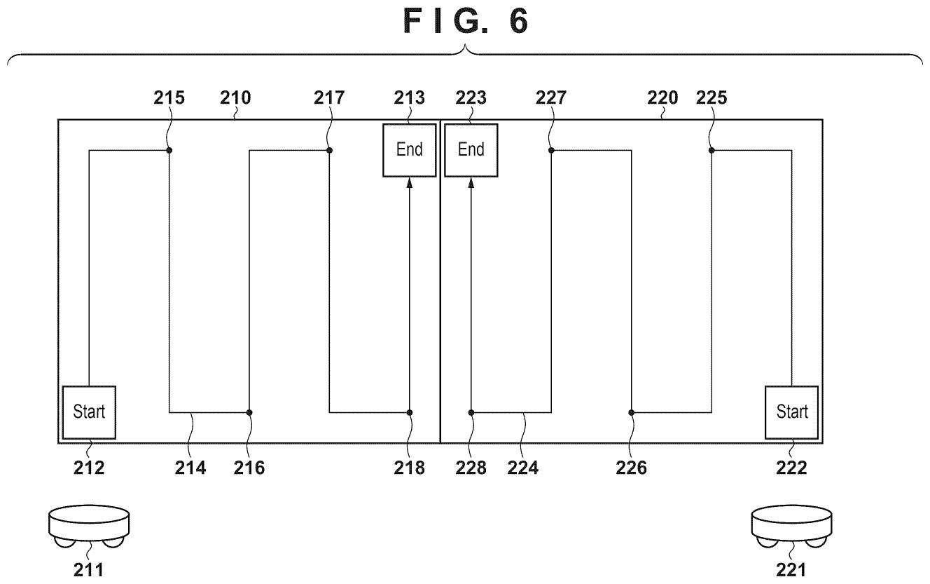

In the first embodiment, an example of determining paths of two moving devices as illustrated in the screen 1100 will be described. Although details will be described later with reference to FIG. 6, a work route is determined such that the moving devices gradually approach each other as the work of each of the moving devices progresses. By this, when work handover is necessary, the moving distance to the area to be handed over is shortened, and the work handover can be performed in a shorter time. Note that the work handover is performed when an unscheduled situation occurs while the work is performed along the work route and work continuation is difficult. The work handover is performed, for example, when work is delayed due to an obstacle or when a remaining charge amount of the moving device, a resource amount (detergent, spray chemicals, or the like) necessary for work, a free capacity of the dust box, or the like is insufficient. In addition, a work robot that has ended the work early shares the work of the work area of the robot that has not completed the work, and hands over the work when the work efficiency as a whole is improved.

### Apparatus Configuration

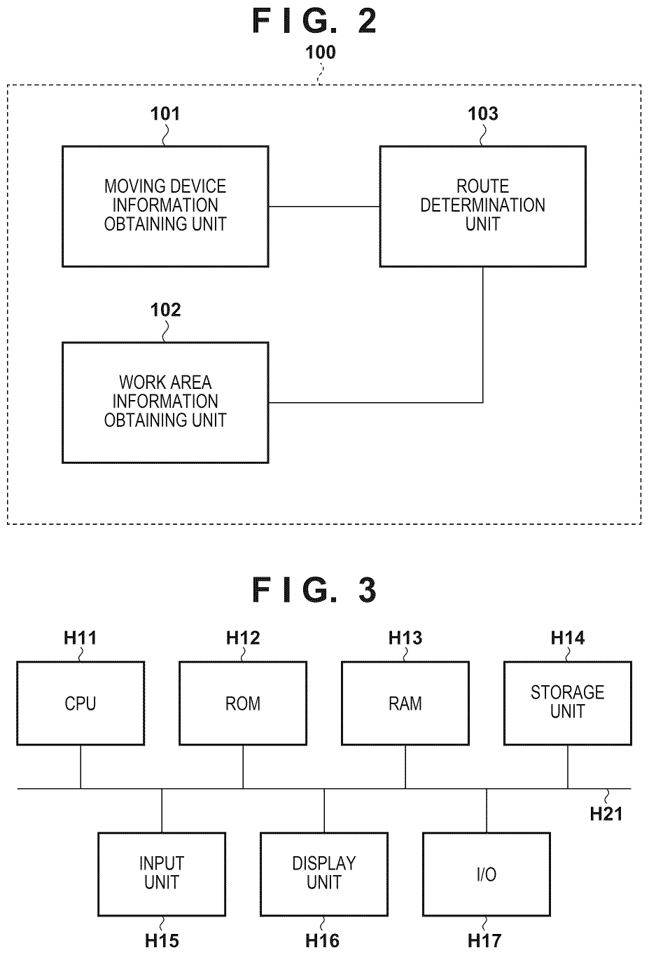

FIG. 2 is a view illustrating a functional configuration of the information processing apparatus 100 according to the first embodiment. A moving device information obtaining unit 101 obtains information (moving speed, work speed, and the like of each moving device) regarding a plurality of moving devices. A work area information obtaining unit 102 obtains information regarding a work area assigned to each moving device. A route determination unit 103 determines a work route of each of the plurality of moving devices. Although details will be described later, the route determination unit 103 determines the work route of each moving device based on the information regarding the moving device obtained by the moving device information obtaining unit 101 and the information regarding the work area obtained by the work area information obtaining unit 102.

FIG. 3 is a view illustrating a hardware configuration of the information processing apparatus 100. H11 is a central processing unit (CPU), and controls various devices connected to a system bus H21. H12 is a read-only memory (ROM), and stores a basic input/output system (BIOS) program and a boot program. H13 is a random access memory (RAM), and is used as a main storage apparatus of the H11, which is a CPU.

H14 is a storage unit including a hard disk drive (HDD) and a solid state drive (SSD), and stores programs and various data to be processed by the information processing apparatus 100. Note that H14 may be configured as a combination of a storage medium such as a compact disc (CD), a digital versatile disc (DVD), a universal serial bus (USB) memory, and an SD card, and an apparatus that reads and writes these storage media.

An input unit H15 is an input unit such as a keyboard, a mouse, and various controllers, and performs processing related to input of information and the like. A display unit H16 is a display unit that displays a calculation result of the information processing apparatus 100. Note that the display unit H16 can be configured by a liquid crystal display apparatus, a projector, an LED indicator, or the like. It is also possible to use a touch screen display or the like in which the input unit H15 and the display unit H16 are integrated. H17 is input/output (I/O) and is a communication interface that exchanges information with various sensors or another information processing apparatus. As described above, it is assumed here that the wireless LAN is used for communication, but the type is not limited.

### Apparatus Operation

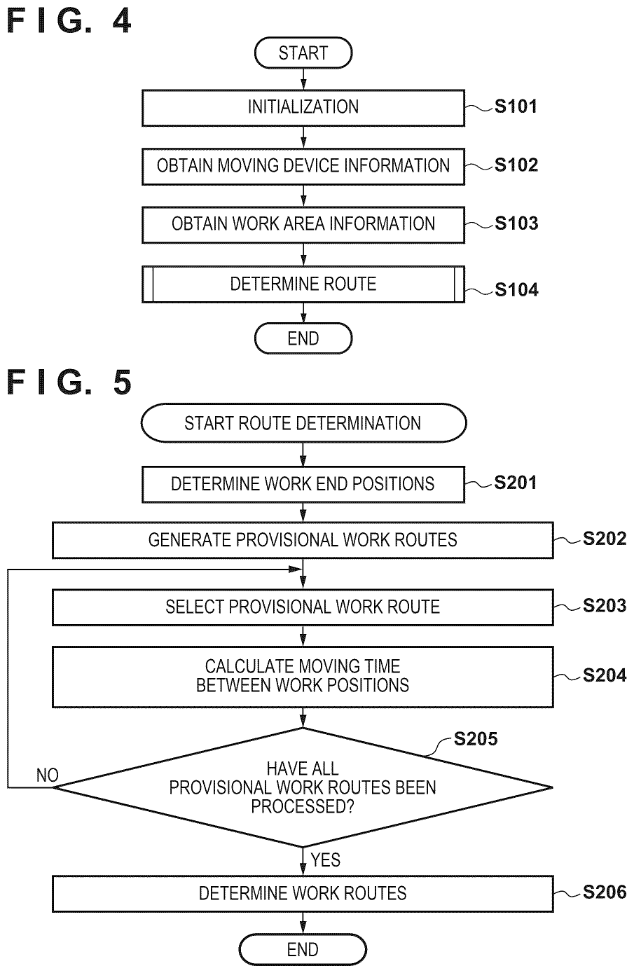

FIG. 4 is a flowchart of processing executed by the information processing apparatus according to the first embodiment. The present processing is executed after sharing of the work area to each moving device over the entire work area is determined. Note that information regarding the sharing of the work area to each moving device is stored in the storage unit H14. The following description assumes that, as illustrated in FIG. 6, a moving device 211 is allocated with a work area 210 and a moving device 221 is allocated with a work area 220.

In step S101, the information processing apparatus 100 performs initialization. That is, a program is read from the storage unit H14 and the information processing apparatus 100 is brought into an operable state. Various setting parameters (e.g., various thresholds described later and the like) are read from the storage unit H14 as necessary.

In step S102, the moving device information obtaining unit 101 obtains information regarding a plurality of moving devices. Here, it obtains a moving speed of each moving device (moving speed in a case of not performing work such as cleaning) and a work speed (defined as faster in speed as the moving speed in a case of performing the work or the time required for each cleaning work is shorter) that are defined in advance. The present information is stored in the storage unit H14 in advance, and is obtained from the storage unit H14 in the present processing.

In step S103, the work area information obtaining unit 102 obtains information regarding a work area assigned to each moving device. Here, it obtains information regarding sharing of the work area to each moving device stored in the storage unit H14 in advance.

In the present embodiment, it obtains information in which a range of a work area (corresponding to the work area 210 and the work area 220 in FIG. 6) assigned to each moving device is recorded on a planar map including the entire area for which work is to be performed. The range of the work area is set as a polygon on the planar map, and is expressed as coordinates of each vertex of the work area in the coordinate system of the planar map. An actual distance between certain points can be obtained based on coordinates on the planar map and scale information on the planar map.

In step S104, the route determination unit 103 determines the work route of each of the plurality of moving devices based on the information regarding the moving device obtained in S102 and the information regarding the work area obtained in S103. Detailed processing will be described later with reference to FIGS. 5 and 6.

After the work route of each moving device is determined, the processing of the present flowchart ends, and each moving device starts work in accordance with the determined work route.

FIG. 5 is a detailed flowchart of the route determination processing (S104) according to the first embodiment. FIG. 6 is a view illustrating an example of route determination.

In step S201, the route determination unit 103 determines work end positions of all moving devices that perform work. As described above, when work handover occurs, the work handover can be performed in a shorter time with the work end positions of the moving devices involved in the handover are close to each other. That is, it is possible to move to the work end position of the other moving device immediately after the work of one moving device is finished and shift to the work in the other work area. Therefore, in the present embodiment, the work end positions are determined so that the moving time between the work end positions of the two moving devices is minimized.

At the time of handover, the efficiency of movement is improved by starting the work from a corner (vertex) position of the work area. Therefore, a combination of vertices in which the moving time between vertices of the work areas of the two moving devices becomes relatively short (desirably becomes the shortest) is determined as the work end positions of the two respective moving devices.

Specifically, two polygons are selected from the polygons indicating the range of the work area assigned to each moving device obtained in S103, and a combination of vertices in which the moving time between the vertices of the two polygons is minimized is extracted. This is performed for all work areas and combinations of all vertices, and two vertices are determined as the work end positions in order from combinations of two work areas having a short moving time between the two vertices. In the example of FIG. 6, the work end position of the moving device 211 is determined to be a position 213, and the work end position of the moving device 221 is determined to be a position 223.

In step S202, the route determination unit 103 generates a provisional work route for ending the work at the work end position determined in S201. In the present embodiment, a plurality of provisional work routes in which the work end position determined in S201 is an end point is generated. For example, using a known technique, a route for moving over all of the work area by a moving path in a zigzag shape or a spiral shape is generated.

In step S203, the route determination unit 103 selects a combination of a pair of provisional work routes based on the plurality of provisional work routes for the plurality of respective moving devices generated in S202. Note that when the process proceeds from S205 described later, a combination of a pair of provisional work routes not processed in S204 is selected.

In step S204, the route determination unit 103 calculates the distance or the moving time (time required for movement) between the plurality of moving devices for the combination of the pair of provisional work routes selected in S203. In the present embodiment, an estimated work position for each unit time when the moving device starts work from the work start position is calculated. Then, the moving time between the estimated work positions at an identical time point of the plurality of moving devices is calculated, and the mean of the moving times is obtained. For the calculation of the estimated work position and the moving time, the information on the work speed and the moving speed of the moving device obtained in S102 is used.

Note that since the moving device may temporarily move in a direction in which the moving time between the estimated work positions becomes long (e.g., in a process of direction change), it is preferable to set the time to a certain length (e.g., 10 seconds). FIG. 6 illustrates estimated work positions (e.g., positions 215 and 225) of the two moving devices at an identical time point. Then, the route determination unit 103 calculates moving times of the positions 215 and 225, positions 216 and 226, positions 217 and 227, and positions 218 and 228, and calculates a mean thereof.

In step S205, the route determination unit 103 determines whether or not selection (S203) and calculation (S204) have been performed on all the combinations of the provisional work routes. If it is determined that all the combinations have been processed, the process proceeds to S206. Otherwise, the process returns to S203.

In step S206, the route determination unit 103 determines a formal work route for each of the plurality of moving devices. In the present embodiment, the pair of provisional work routes in which the mean of the moving times calculated in S204 is relatively short (desirably becomes the shortest) is determined as the formal work route.

FIG. 6 illustrates an example in which a provisional work route 214 is determined as a formal work route for the moving device 211, and a provisional work route 224 is determined as a formal work route for the moving device 221. As illustrated in the provisional work route 214 and the provisional work route 224, a route in which the moving devices move away from each other with time going back from the work end positions (positions 213 and 223) of the respective moving devices is selected. In other words, a route in which the two moving devices are farthest from each other at the time of work start (positions 212 and 222) and approach each other over time is selected.

As described above, according to the first embodiment, the work routes of the respective moving devices are determined in consideration of the moving time between the work positions of the plurality of moving devices. By performing work on the work route determined in this manner, when work handover occurs, the moving device of the handover destination can move to the work end area of the moving device of the handover source in the shortest moving time. That is, the movement efficiency at the time of handover is enhanced.

### Modification 1

In the first embodiment, a planar map is used as a map in which the work area information is recorded, but the present invention is not limited to this, and for example, a three-dimensionally expressed map may be used. A map created from actual measurement, a map generated from a design drawing such as CAD, or a handwritten map may be used. A feature amount map when the moving device estimates the self position may be used. The plurality of pieces of map information described above may be used in combination.

The work area for each moving device may be determined by automatically dividing the entire work area based on information on each moving device, or may be manually set by the user.

In the first embodiment, the work end position is determined so that the moving time between the work end positions of the moving devices is minimized, but the work end position may be determined so as to be shorter than a predetermined threshold. Since it may quickly move to the work area of another moving device at the time of handover, the work end position may be determined such that the moving time between the work end position of the target moving device and the area assigned to the other moving device becomes relatively short.

In a case of working separately on each floor or in each room, movement between work areas is performed via an entrance/exit of the room and an elevator. Therefore, a position adjacent to the position of the entrance/exit or the elevator or a position within a predetermined threshold may be determined as a work end position. Furthermore, the moving time may be calculated by correcting the work speed and the moving speed of the moving device based on the material of the floor between the work areas and the information on the obstacle on the moving path.

Note that in the first embodiment, the processing is performed on all combinations of work areas, but in a case where the work areas are far from each other, the moving distance at the time of handover becomes long, and the movement efficiency drops. Therefore, the processing may be performed only by a combination of adjacent work areas or a combination of work areas in a distance within a predetermined threshold.

In the first embodiment, as the selection method of a work route, the provisional work route in which the mean of the moving time between the estimated work positions is minimized is selected, but the provisional work route may be not the shortest but within a predetermined threshold. An area closer to the work end area becomes a work uncompleted area at the time of handover, and therefore, the weight may be increased and calculated more with respect to the moving time between estimated work positions at a position closer to the work end position. That is, when the mean of the moving time between the estimated work positions is calculated, the value of the coefficient to be multiplied is increased as the moving time between the estimated work positions closer to the work end position.

At the time of calculating the moving time between the estimated work positions, the moving time may be calculated by correcting the work speed and the moving speed of the moving device based on the information on the speed of a direction change of the moving device, the material of the floor, and an obstacle on the moving path. Furthermore, since the movement efficiency at the time of handover is high by the work end positions being close to each other, selection processing of a provisional work route that minimizes the mean of the moving times between the estimated work positions may be skipped, only one generated provisional work route may be a formal work route, with any moving path in the middle.

In addition, regarding the moving path, the moving direction (vertical direction in FIG. 6) in which work excluding the moving direction by direction change of the moving device is performed may be determined so as to be parallel in each moving device. This makes it possible to continue the work in the same direction even when handover occurs, and the movement efficiency after the handover is enhanced.

In the first embodiment, the work start position is a position determined at the time of generating the provisional work route, but a constraint may be provided for the work start position. Specifically, in step S204, a constraint that the moving time between the work start positions becomes relatively long (desirably becomes the longest) or is a predetermined threshold or more may be added. By doing this, the work start positions are separated from each other, and the work end positions are determined to be close to each other. Therefore, the moving device approaches the other moving device as the work progresses. Therefore, since the work uncompleted area at the time of handover is positioned close to the other moving device, the movement efficiency at the time of the work after the handover is enhanced. Similarly, the work start position may be a position at an end of the entire work area so that the work start positions are at positions separated from each other.

Alternatively, the shortest position in an assigned work area from the current position of the moving device may be determined as a work start position, and the movement efficiency up to the work start may be enhanced. A work start position determined in advance by the information processing apparatus 100 or an external system for each work area may be used, or the user may designate the work start position for each moving device.

In the first embodiment, the provisional work route is generated after the work end position is determined first, but the provisional work route may be generated after the work start position is determined. In this case, as the work end position, the end point of the moving path generated by provisional work route generation is the work end position. The work start positions are determined so as to be at positions separated from each other as described above, and a provisional work route in which the estimated work positions are close to each other is selected similarly to the first embodiment from among the plurality of generated provisional work routes. By doing this, the provisional work route approaching from the separated work start position is selected, and as a result, the work end position is also at a close position.

In the first embodiment, the work route is determined in order from combinations of two work areas having a short moving time between the two vertices of a polygon serving as a work area, but the work route of three or more work areas may be determined simultaneously. Specifically, a plurality of provisional work routes are generated for all the work areas, and one provisional work route is selected for each work area from the plurality of provisional work routes. Then, the total or mean of the moving times of the work end positions of all the provisional work routes is calculated. In this manner, the total or mean of the moving times of the work end positions is calculated for all combinations of the provisional work routes. Thereafter, the provisional work route in which the calculated value is relatively short (desirably becomes the shortest) or falls within a predetermined threshold may be determined for each work area.

In the above description, the moving time of the moving device is used for determination, but the moving distance may be used in place of the moving time. That is, the moving distance may be calculated, and it may be determined that the position is close due to the moving distance being short or the position is far due to the moving distance being long.

Note that in the first embodiment, the information processing apparatus 100 is an instance on a server, a PC, or a cloud, but the present invention is not limited to this, and the information processing apparatus 100 may be mounted on a moving device and the moving device itself may determine a route. The information processing apparatus 100 may be mounted on the terminal 1002.

### Second Embodiment

In the second embodiment, an example of determining a work route in consideration of work performance (work speed) of a moving device will be described. The functional configuration and the entire processing are similar to those of the first embodiment, and thus description thereof will be omitted.

### Apparatus Operation

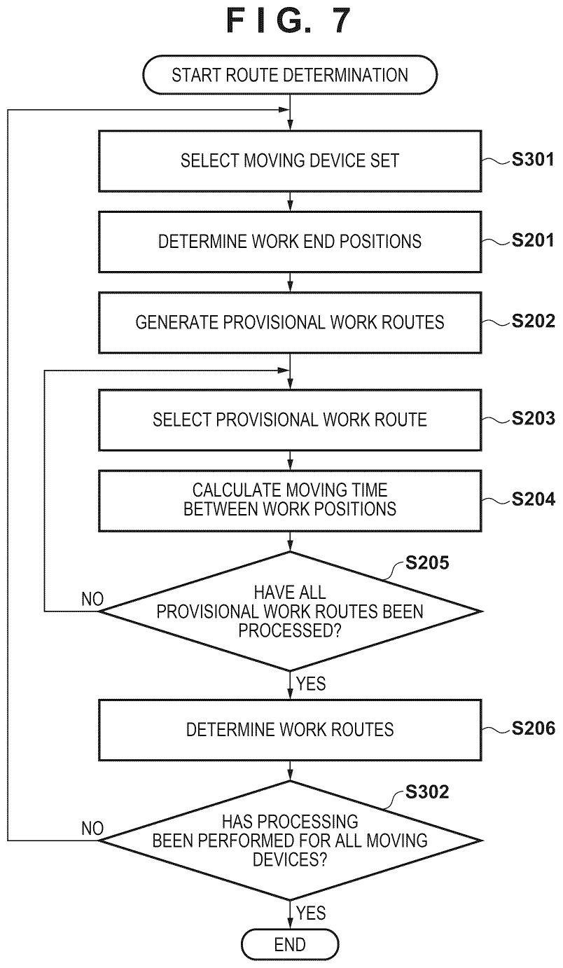

FIG. 7 is a detailed flowchart of the route determination processing (S104) according to the second embodiment. Note that S201 to S206 are similar to those of the first embodiment (FIG. 5), and thus description thereof will be omitted.

In step S301, the route determination unit 103 selects a set of two moving devices in descending order of the difference in work speed from among the plurality of moving devices obtained in S102. Note that when the process proceeds from S302 described later, a set of two unprocessed moving devices having the next largest difference in work speed is selected.

In step S302, the route determination unit 103 determines whether or not the processing of S201 to S206 has been performed on all the combinations of the moving devices. If it is determined that all the combinations have been processed, the present flowchart is ended, and otherwise, the process returns to S301.

### Example of Route Determination

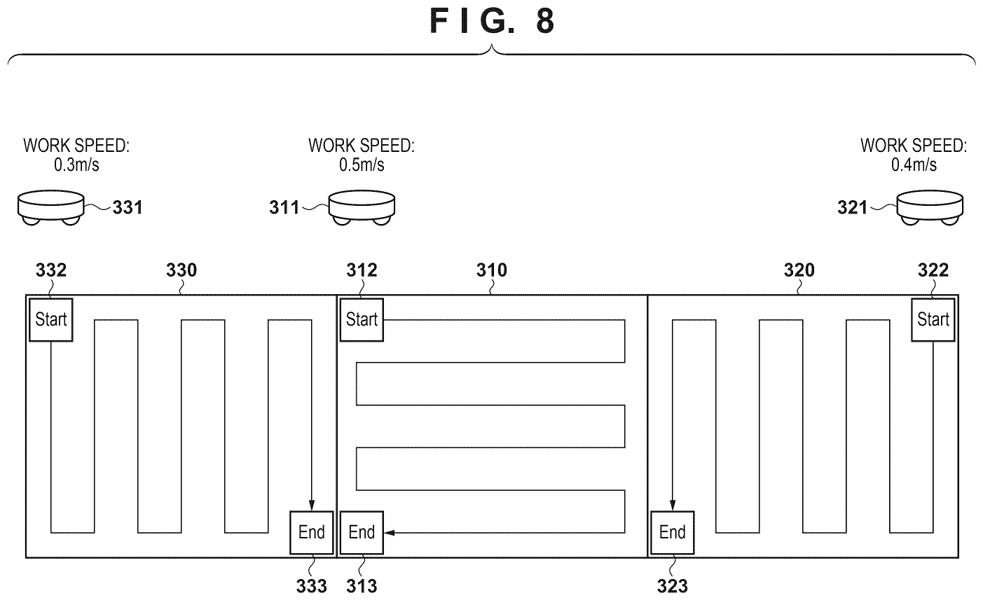

FIG. 8 is a view illustrating an example of route determination. Here, a case where work areas 310, 320, and 330 are shared respectively by moving devices 311, 321, and 331 to perform work is assumed. The work speed of each moving device is 0.5 m/s for the moving device 311, 0.4 m/s for the moving device 321, and 0.3 m/s for the moving device 331. In this case, the difference between the work speed of the moving device 311 and the work speed of the moving device 331 is the largest. Therefore, the work route is determined such that a work end position 313 of the moving device 311 and a work end position 333 of the moving device 331 are close to each other.

As described above, according to the second embodiment, the work route is determined with priority given to a work end position being closer for a combination of moving devices having a large difference in work speed. A moving device with a low work speed is likely to be work uncompleted, and a moving device with a high work speed is likely to be a moving device of a handover destination, and therefore movement efficiency at the time of handover is enhanced.

### Modification

In the second embodiment, the set of moving devices is selected in descending order of the difference in the work speed, but the present invention is not limited to this, and a predicted work time required up to work completion may be calculated (predicted) based on the work speed of the moving device, and the set of moving devices having the maximum difference in the predicted work time may be selected.

Furthermore, in place of the work speed of the moving device, the remaining charge amount of the battery, the remaining amount of the agent (detergent, spray chemicals, or the like) necessary for work, and a free capacity of the dust box may be used. In a case of a moving device with a small remaining amount of them, there is a high possibility that the work cannot be continued in the middle of the work, and therefore, the work end position of the target moving device may be determined so as to be close to the work end position of the moving device with a small remaining resource amount. Specifically, the work route may be determined by selecting the set of moving devices in descending order of the difference in the remaining resource amount.

In addition, as environment information in the work area, information on the density of moving devices (including a human and a robot) existing in the work area, the material of the floor, the shape such as unevenness, or the like, and an obstacle existing in the work area may be obtained, and a decrease in work speed due to them may be taken into consideration. Specifically, the work route may be determined by calculating the predicted work time when the work speed decreases and selecting the set of moving devices in descending order of the difference in the predicted work time.

The work route may be determined by selecting a set of a moving device with high frequency and a moving device with low frequency that cannot continue the work based on work performance data of the past.

Note that when a set of two moving devices is selected, if a moving device assigned to a far place is selected, the movement efficiency is likely to drop. Therefore, a set of moving devices in which assigned work areas are adjacent to each other or at a distance within a predetermined threshold may be selected.

### Third Embodiment

In the third embodiment, an example of correcting a work route based on a current position during work of the moving device will be described.

### Apparatus Configuration

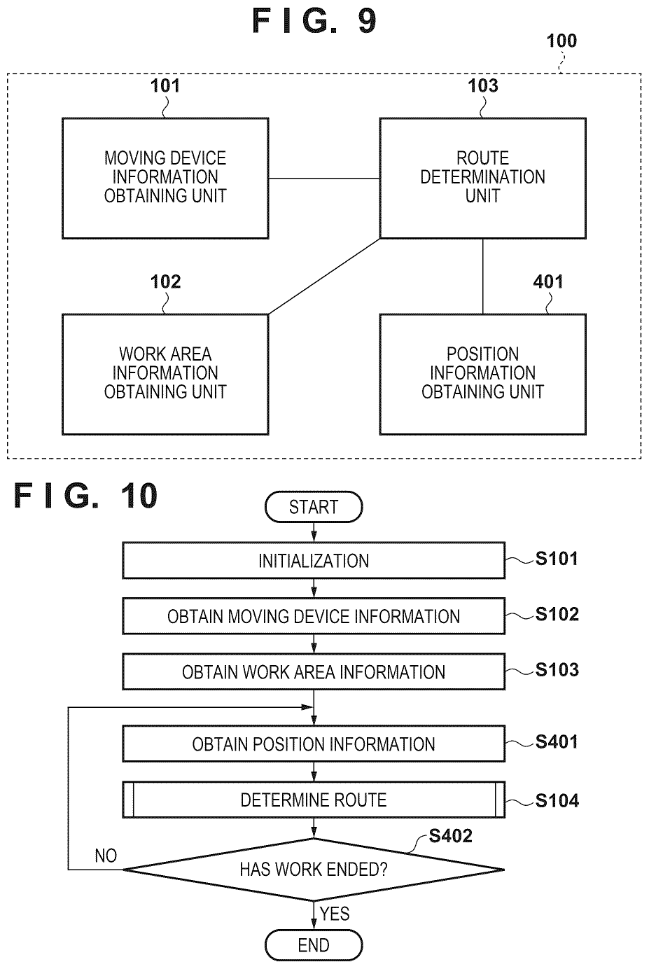

FIG. 9 is a view illustrating a functional configuration of the information processing apparatus 100 according to the third embodiment. It is different from the first embodiment (FIG. 2) in including a position information obtaining unit 401.

The position information obtaining unit 401 obtains a current position (coordinates) of each moving device during work. The current position is obtained as a position on the planar map used in the first embodiment.

### Apparatus Operation

FIG. 10 is a flowchart of processing executed by the information processing apparatus according to the third embodiment. Note that S103 and S104 are similar to those of the first embodiment (FIG. 4), and thus description thereof will be omitted.

In step S401, the position information obtaining unit 401 obtains the current position of each moving device. In the present embodiment, the self position on a map for self position estimation of the moving device is mapped to the position on the planar map. For example, the planar map may be enlarged or reduced so as to have the same size as that of the map for self position estimation, and superimposed so that some points serving as landmarks on the map are aligned. In the present embodiment, the current position is obtained every predetermined time (e.g., every minute) after the start of the work. Each time the current position is obtained, the work route is reset, and the work route is determined again. Note that if the work is not started yet, the current position is not obtained, and the operation is performed as work route determination processing before the start of the work similarly to FIG. 4. Before the start of the work and after the work route before the start of the work is determined, the process waits until the work is started.

In step S104, the route determination unit 103 performs processing similar to that of the second embodiment (FIG. 7) basically. However, in the processing after the start of the work, in S301, a set of moving devices is selected based on the current position of each moving device obtained in S401. In the present embodiment, a set of two moving devices in which the difference in the remaining work time from the current position of the moving device obtained in S401 to the work end position determined in S201 is maximized is selected. Note that as the work end position, the work end position determined last time is used. Thereafter, in S206, a work route with the shortest moving time between the work end positions is determined for the selected two moving devices.

In step S402, the route determination unit 103 determines whether or not all the moving devices have ended the work. If it is determined that the work is ended, the present flowchart is ended, and otherwise, the process returns to S401.

### Example of Route Determination

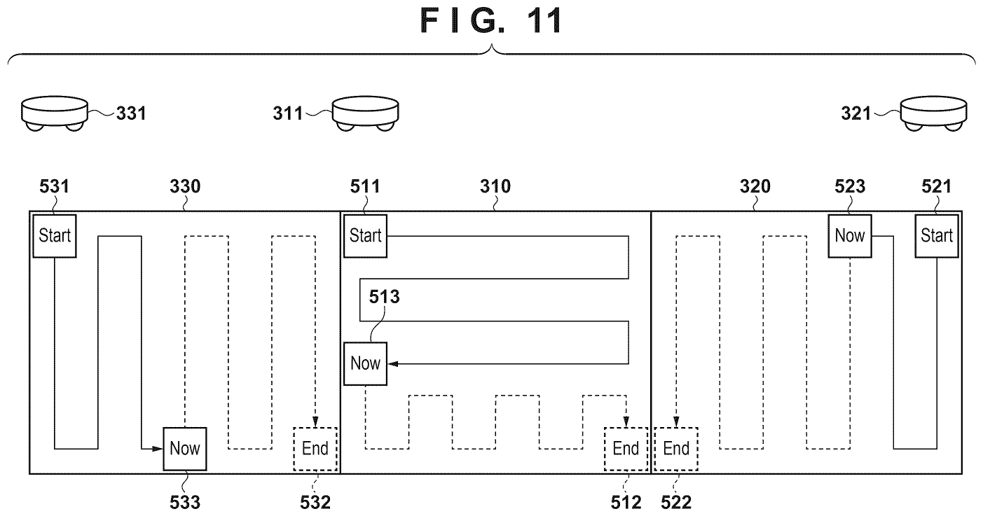

FIG. 11 is a view illustrating an example of route determination. Here, similarly to the second embodiment (FIG. 8), a case where the work areas 310, 320, and 330 are shared respectively by the moving devices 311, 321, and 331 to perform work is assumed. It is assumed that the work route illustrated in FIG. 8 is determined for each moving device at a time point before the start of the work. That is, before the start of the work, the work end position of the moving device 311 is set to a position close to the work end position of the moving device 331 as in FIG. 8. FIG. 11 illustrates a state at a certain time point (current time) during work after the work is started, and a position indicated by “Now” represents the current position of each moving device.

It is assumed that the work of the moving device 311 has progressed to a current position 513, and the remaining work time from the current position 513 to the scheduled work end position (work end position 313 in FIG. 8) is 10 minutes. Similarly, it is assumed that the remaining work time of the moving device 331 from a current position 533 to a work end position 532 is 20 minutes. It is assumed that the moving device 321 has a work speed higher than that of the moving device 331, but an unexpected situation such as a voltage drop or a work delay due to an obstacle has occurred, and the remaining work time from a current position 523 to a work end position 522 is 30 minutes, which is more than the moving device 331.

Therefore, the combination of the moving devices having the maximum difference in the work time is a combination of the moving device 311 (remaining work time of 10 minutes) and the moving device 321 (remaining work time of 30 minutes). Therefore, the work end position of the moving device 311 (that is a moving device with a short remaining work time) is corrected to a work end position 512 such that the moving time between the work end positions of the moving device 311 and the moving device 321 is minimized. With this, the work route is also corrected.

As described above, according to the third embodiment, after the start of the work by each moving device, the work route is corrected based on the current position of each moving device during work. In particular, the work route is corrected such that the work end positions of the moving device estimated to have the longest remaining work time and the moving device estimated to have the shortest remaining work time are close to each other. This enhances the movement efficiency at the time of handover.

### Modification 3

In the third embodiment, the current position is obtained as position information, but an estimated position after a lapse of a predetermined time or an estimated work end position at a work end time point set in advance may be obtained. If the obtaining frequency of position information is made high, waste increases, and if it is made too low, correction of the work route is delayed. Therefore, in the above description, obtaining is performed every minute, but another obtaining interval may be adopted.

In the third embodiment, a set of moving devices is selected based on the current position of each moving device. At this time, even if a moving device assigned to a far place is selected, the movement efficiency drops, and therefore, the set of moving devices may be selected from moving devices in which the work areas assigned to the moving devices are adjacent to each other or at a distance within a predetermined threshold.

In the third embodiment, the set of moving devices having the maximum difference in remaining work time is selected, and the route is corrected so that the work end positions are close to each other, but the present invention is not limited to this. For example, the moving device may be selected in ascending order of the estimated work end time, and the route may be corrected so as to be close to the work end position of the moving device having the largest remaining work time calculated based on the estimated work position of another moving device at the estimated work end time of the selected moving device.

In the third embodiment, the route correction is performed at a regular timing, but the route correction may be performed at another timing. For example, route correction may be performed by receiving a notification when a change such as a decrease in the work speed of the moving device or a stop occurs, or when the moving device deviates from the work route, and obtaining position information with the notification as a trigger. In addition, route correction may be performed by receiving a notification when a resource shortage in remaining amount information (remaining charge amount of battery, remaining amount of agent (detergent, spray chemicals, or the like) necessary for work, free capacity of dust box, and the like) is detected, or when it is difficult to continue the work due to a trouble or the like.

In the third embodiment, the processing before the start of the work and the processing after the start of the work are identical, but the processing before the start of the work and the processing after the start of the work may be different. For example, the processing illustrated in FIG. 4 may be performed before the start of the work, and the processing illustrated in FIG. 7 may be performed after the start of the work.

### Fourth Embodiment

In the fourth embodiment, an example of determining a work route after work handover will be described.

### Apparatus Configuration

FIG. 12 is a view illustrating a functional configuration of the information processing apparatus 100 according to the fourth embodiment. It is different from the first embodiment (FIG. 2) in including a handover area information obtaining unit 601.

When it is determined to hand over the work between the moving devices, the handover area information obtaining unit 601 obtains information on the handover area that is a target of handover. The handover area is an area corresponding to a part or entirety of a portion that is a work uncompleted area, and can be determined by the method disclosed in Patent Document 1. The information on the handover area is obtained as coordinate information on a polygon on the planar map used also in the first embodiment.

### Apparatus Operation

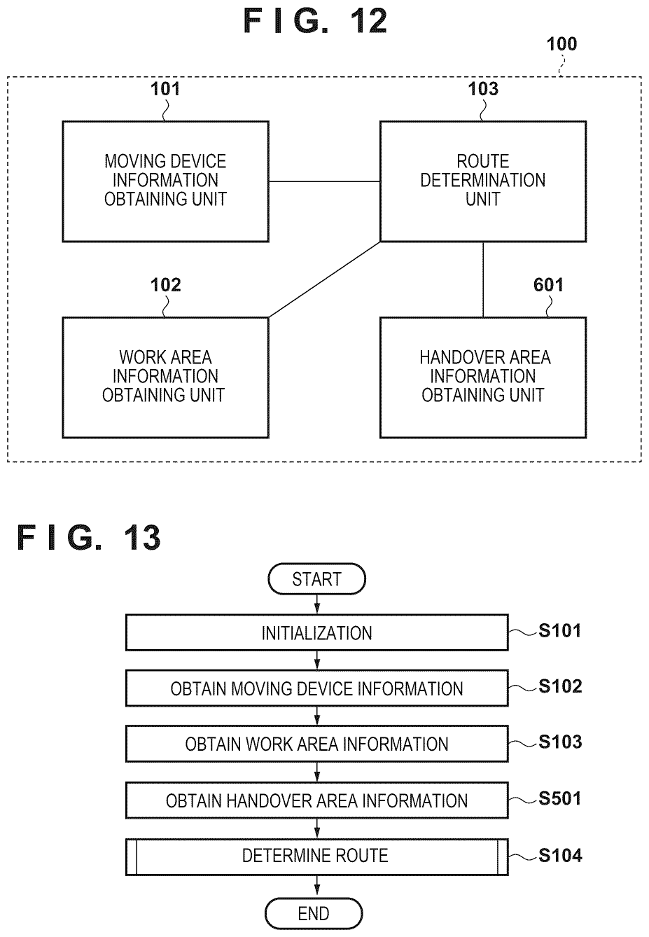

FIG. 13 is a flowchart of processing executed by the information processing apparatus according to the fourth embodiment. Note that S103 and S104 are similar to those of the first embodiment (FIG. 4), and thus description thereof will be omitted.

In step S501, the handover area information obtaining unit 601 obtains information on the handover area. At this time, the moving device of the handover destination handles the information on the handover area as new work area information.

As described above, according to the fourth embodiment, the route is determined so that the work end positions of the moving devices are close to each other in preparation for further handover also in the handover area. This enhances the movement efficiency when the moving device of the handover destination described above further hands over another work area or when a portion of the handed over area is handed over by another moving device (when the work is delayed).

### Modification 4

In the fourth embodiment, the route is determined such that the work end positions of the respective moving devices are close to each other also in the handover area similarly to the first embodiment, but the present invention is not limited to this. For example, the work end position of the moving device of the handover source and the work end position of the moving device of the handover destination are close to each other. Therefore, the work route may be determined such that the original work route is traveled in the reverse direction from the work end position before being simply handed over. In order to share a work uncompleted area (narrower than the work area of each moving device), a predetermined distance margin may be taken between the moving paths so that the moving devices do not collide with each other. Furthermore, the estimated work position for each unit time may be calculated in consideration of the work speed, and a predetermined distance margin may be taken when the position of the moving device at an identical time is estimated to be close.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-081117, filed May 17, 2024 which is hereby incorporated by reference herein in its entirety.

What is claimed is:

1. An information processing apparatus comprising:
a first obtaining unit that obtains information regarding a moving speed of each of a plurality of moving devices that will be performing work in a shared manner over an entire work area;
a second obtaining unit that obtains information on a work area assigned to each of the plurality of moving devices; and
a determination unit that determines a work route of each of the plurality of moving devices based on a moving speed of each of the plurality of moving devices and a work area of each of the plurality of moving devices, wherein
the determination unit determines a work route of each of the plurality of moving devices based on a change in distance between the plurality of moving devices or a change in time required for movement between the plurality of moving devices after work of the plurality of moving devices is started.

2. The information processing apparatus according to claim 1, wherein
the determination unit determines a work route of each of the plurality of moving devices such that a distance between the plurality of moving devices or a time required for movement between the plurality of moving devices becomes shorter over time.

3. The information processing apparatus according to claim 1, wherein
the determination unit determines a work route of each of the plurality of moving devices such that a distance between work end positions of each of the plurality of moving devices or a time required for movement between work end positions of each of the plurality of moving devices becomes relatively short.

4. The information processing apparatus according to claim 1, wherein
the determination unit determines a work route of each of the plurality of moving devices such that a distance between work start positions of the plurality of moving devices or a time required for movement between work start positions of the plurality of moving devices becomes relatively long.

5. The information processing apparatus according to claim 1, wherein
the plurality of moving devices include a first moving device and a second moving device, and
the determination unit determines a work route of each of the plurality of moving devices such that a distance or a time required for movement between a work end position of the first moving device and a work area assigned to the second moving device becomes relatively short.

6. The information processing apparatus according to claim 1, wherein
the plurality of moving devices include a first moving device and a second moving device, and
the determination unit determines a work route of each of the plurality of moving devices such that a distance or a time required for movement between a work start position of the first moving device and a work area assigned to the second moving device becomes relatively long.

7. The information processing apparatus according to claim 1, wherein
the determination unit determines a work route of each of the plurality of moving devices such that a work start position of each of the plurality of moving devices is positioned at an end of the entire work area.

8. The information processing apparatus according to claim 1, wherein
the determination unit determines a work route of each of the plurality of moving devices such that a moving direction during work of each of the plurality of moving devices become parallel.

9. The information processing apparatus according to claim 1, wherein
the determination unit predicts a predicted work time required up to work completion by each of the plurality of moving devices based on a moving speed of each of the plurality of moving devices and a work area of each of the plurality of moving devices, and
the determination unit determines a work route of each of the plurality of moving devices such that a distance or a time required for movement between a work end position of a first moving device included in the plurality of moving devices and a work area assigned to a second moving device having a relatively large difference from a predicted work time of the first moving device becomes relatively short.

10. The information processing apparatus according to claim 9, wherein
the first obtaining unit further obtains remaining amount information regarding a remaining resource amount of each of the plurality of moving devices,
the determination unit corrects a predicted work time predicted for each of the plurality of moving devices based on the remaining amount information, and
the remaining amount information includes information regarding at least one of a remaining charge amount of a battery, a remaining amount of an agent required for work, and a free capacity of a dust box.

11. The information processing apparatus according to claim 9, wherein
the second obtaining unit further obtains environment information regarding an environment of a work area of each of the plurality of moving devices,
the determination unit corrects a predicted work time predicted for each of the plurality of moving devices based on the environment information, and
the environment information includes information regarding at least one of a density of moving devices existing in a work area, a material and a shape of a floor of a work area, and an obstacle existing in a work area.

12. The information processing apparatus according to claim 1 further comprising:
a third obtaining unit that obtains position information on the plurality of moving devices, wherein
the determination unit corrects a work route of each of the plurality of moving devices based on positions of the plurality of moving devices after work of the plurality of moving devices is started.

13. The information processing apparatus according to claim 1 further comprising:
a handover determination unit that determines handing over a work uncompleted area of a first moving device from the first moving device included in the plurality of moving devices to a second moving device different from the first moving device, wherein
when the handover determination unit determines handing over the work uncompleted area to the second moving device, the determination unit determines a work route of each of the first moving device and the second moving device based on the work uncompleted area.

14. The information processing apparatus according to claim 1, wherein
the second obtaining unit further obtains a position of an entrance/exit through which a moving device can enter and exit in a work area of each of the plurality of moving devices, and
the determination unit determines a work route of each of the plurality of moving devices such that a distance or a time required for movement between a work end position of the moving device and a position of an entrance/exit of a work area assigned to the moving device becomes shorter than a predetermined threshold in at least one moving device included in the plurality of moving devices.

15. A control method of an information processing apparatus that determines a work route of each of a plurality of moving devices that will be performing work in a shared manner over an entire work area, the control method comprising:
first obtaining of obtaining information regarding a moving speed of each of the plurality of moving devices;
second obtaining of obtaining information on a work area assigned to each of the plurality of moving devices; and
determining a work route of each of the plurality of moving devices based on a moving speed of each of the plurality of moving devices and a work area of each of the plurality of moving devices, wherein
in the determining, a work route of each of the plurality of moving devices is determined based on a change in distance between the plurality of moving devices or a change in time required for movement between the plurality of moving devices after work of the plurality of moving devices is started.

16. A non-transitory computer-readable recording medium storing a program that, when executed by a computer, causes the computer to perform a control method of an information processing apparatus that determines a work route of each of a plurality of moving devices that will be performing work in a shared manner over an entire work area, the control method comprising:
first obtaining of obtaining information regarding a moving speed of each of the plurality of moving devices;
second obtaining of obtaining information on a work area assigned to each of the plurality of moving devices; and
determining a work route of each of the plurality of moving devices based on a moving speed of each of the plurality of moving devices and a work area of each of the plurality of moving devices, wherein
in the determining, a work route of each of the plurality of moving devices is determined based on a change in distance between the plurality of moving devices or a change in time required for movement between the plurality of moving devices after work of the plurality of moving devices is started.
